(19) United States
(12) Patent Application Publication
(10) Pub. No.: US 2015/0198137 A1
(43) Pub. Date: Jul. 16, 2015

(54) HYDRODYNAMIC ENERGY GENERATION SYSTEM

(71) Applicant: Ibrahim Hanna, Miami, FL (US)

(72) Inventor: Ibrahim Hanna, Miami, FL (US)

(21) Appl. No.: 14/195,133

(22) Filed: Mar. 3, 2014

Related U.S. Application Data
(60) Provisional application No. 61/925,828, filed on Jan. 10, 2014.

(51) Int. Cl. F03B 13/10

(52) U.S. Cl. CPC F03B 13/10; Y10S 415/916; F03B 17/005

(57) ABSTRACT

The hydrodynamic energy generation system includes a vertically aligned housing comprising a hollow interior and an opening at a top, wherein the housing is at least partially submerged in a body of water, a valve coupled to a top of the housing for regulating an amount of water that enters the opening, wherein the valve is located at or under a water line, a water wheel located below the valve and within the housing, wherein the water wheel is mechanically coupled to a generator that produces electrical power when the water wheel is moved by water that falls into the housing, a reservoir for holding the water that has travelled via the water wheel, and at least one pump for jettisoning water from the reservoir, wherein a predefined amount of water is maintained in the reservoir so as to substantially eliminate buoyancy forces on the system.

### CROSS-REFERENCE TO RELATED APPLICATIONS

This patent application claims priority to provisional patent application No. 61/925,828 filed Jan. 10, 2014 and entitled “Hydrodynamic Energy Generation System.” Provisional patent application No. 61/925,828 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The present invention relates to the field or energy production, and more specifically relates to the field of energy production via hydrodynamic sources.

### BACKGROUND OF THE INVENTION

A power generating station is an industrial machine or plant for the generation of electric power. At the center of nearly all power generating stations is a generator, which typically includes a rotating machine that converts mechanical power into electrical power by creating relative motion between a magnetic field and a conductor. The energy source harnessed to turn the generator varies widely—from moving water and wind, to fossil fuels (such as coal, oil, and natural gas) and nuclear material. In recent times, however, due to the decreasing reserves of fossil fuels and the environmental impact of their use in power generation, cleaner alternatives for the generation of power have become more popular.

Cleaner alternatives for power generation include solar, wind, wave, and geothermal sources. Despite the fact that they are considerably more environmentally-friendly, these alternative power generation techniques have struggled to gain widespread acceptance due to their inefficiencies in generating power, their high cost to establish in comparison to existing fossil fuel technology and their lack of aesthetic appeal (such as wind farms). Another reason for the lack of popularity of cleaner power generation alternatives is the political power of the existing power generation entities. Oil companies, for example, have significant political sway in the United States, as well as abroad, and have resisted attempts to introduce alternative fuel sources into the power generation industry.

One of the most promising clean power generation alternatives is hydroelectric power. Hydroelectricity refers to electricity generated by hydropower, i.e., the production of electrical power through the use of the gravitational force of falling or flowing water. Although hydroelectric power is one of the cleanest and most environmentally-friendly sources of energy, it also has the capability to alter or damage its surroundings. Among the main problems that have been demonstrated by hydroelectric power is significant change in water quality. Because of the nature of hydroelectric systems, the water used in the system can often take on a higher temperature, lose oxygen content, experience siltation, and gain in phosphorus and nitrogen content. This can have a major impact on aquatic life near the region of a hydroelectric plant.

Another major problem with hydroelectric power is the obstruction of a body of water, such as a river, for aquatic life. When used in the context of a flowing body of water, such as a river, a hydroelectric plant can obstruct the natural migration of aquatic life. Salmon, for example, which migrate upstream to spawn every year, are especially impacted by hydroelectric dams.

Therefore, a need exists to overcome the problems with the prior art as discussed above, and particularly for a more efficient way of providing cleaner and more environmentally friendly alternatives for power generation, namely, hydroelectric power generation.

### SUMMARY OF THE INVENTION

A hydrodynamic energy generation system is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, the hydrodynamic energy generation system includes a vertically aligned housing comprising a hollow interior and an opening at a top, wherein the housing is at least partially submerged in a body of water, a valve coupled to a top of the housing for regulating an amount of water that enters the opening at the top and falls into the housing, wherein the valve is located at or under a water line, a water wheel located below the valve and within the housing, wherein the water wheel is mechanically coupled to a generator that produces electrical power when the water wheel is moved by water that falls into the housing, a reservoir located below the water wheel and within the housing, wherein the reservoir holds the water that has travelled via the water wheel, and at least one pump for jettisoning water from the reservoir, wherein a predefined amount of water is maintained in the reservoir so as to substantially eliminate buoyancy forces on the system. In another embodiment, the hydrodynamic energy generation system includes a control processor coupled with the valve and the at least one pump for controlling said valve and the at least one pump.

The foregoing and other features and advantages will be apparent from the following more particular description of the preferred embodiments, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a block diagram illustrating the hydrodynamic energy generation system, in accordance with one embodiment.

FIG. 2 is a block diagram illustrating the hydrodynamic energy generation system, in accordance with an alternative embodiment.

FIG. 3 is a flow chart depicting the method of the hydrodynamic energy generation system, in accordance with one embodiment.

FIG. 4 is a block diagram of a system including an example computing device and other computing devices.

FIG. 5 is a block diagram illustrating the hydrodynamic energy generation system, in accordance with yet another alternative embodiment.

FIG. 6 is a block diagram illustrating the hydrodynamic energy generation system, in accordance with yet another alternative embodiment.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

In accordance with the embodiments described herein, a hydrodynamic energy generation system is disclosed that overcomes the problems with the prior art as discussed above, by providing an energy generation system that utilizes clean, renewable energy and does not produce waste. As an improvement over conventional energy generation systems, the disclosed systems allows for the production of energy using falling water that is plentiful and renewable, without the drawbacks of burning fossil fuels—i.e., waste products. Also, the hydrodynamic energy generation system provides a system with a minimal number of component parts, thereby reducing the potential for failure or malfunction of its combination parts. Further, the minimal number of component parts allows for quick and inexpensive fabrication of the combination parts, thereby resulting in an economical system. Lastly, the hydrodynamic energy generation system is easily maneuverable, easily transportable, inexpensive to manufacture and lightweight in its physical characteristics.

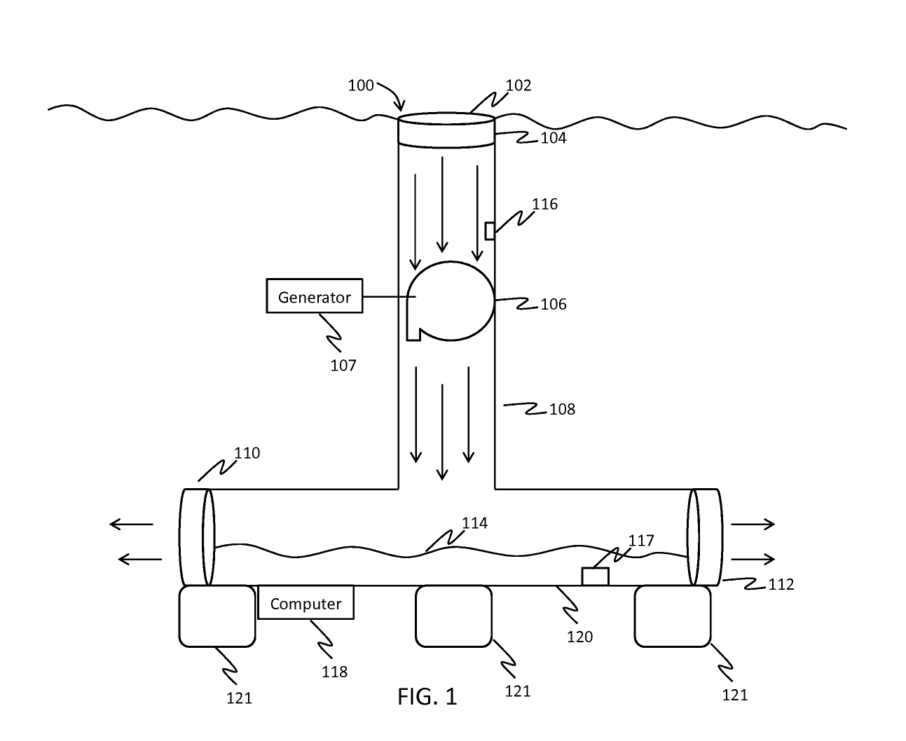

The embodiments of the hydrodynamic energy generation system will be described heretofore with reference to FIGS. 1 through 6 below. FIG. 1 is a block diagram illustrating the hydrodynamic energy generation system 100, in accordance with one embodiment. The hydrodynamic energy generation system 100, which is fully or partially submerged in a body of water (such as an ocean, lake or river) may be composed of a vertically aligned element 108, otherwise known as a housing, comprising a hollow interior and an opening 102 at the top. The vertically aligned element 108 may comprise a tubular structure, and may, alternatively, integrate a horizontal part or different portions in a variety of sequences or configurations. The opening 102 and/or valve 104 may be located at or under the water line of the body of water in which the system 100 is submerged, so as to allow water to enter the top of the housing 108.

The hydrodynamic energy generation 100 may further include a valve 104 coupled to the top of the vertical element 108 for regulating an amount of water that enters the opening 102 at the top. The valve 104 may comprise one or more valves for regulating flow of water, such as a ball valve, a butterfly valve, a gate valve, a globe valve, a needle valve, a spool valve or a safety valve. The valve 104 may further be a check valve or foot valve, which are unidirectional valves that only allow water to flow in one direction.

The hydrodynamic energy generation 100 may further include a water wheel and/or turbine 106 (chained or otherwise mechanically coupled with a generator 107), wherein the water wheel and/or turbine is located below the valve 104. The generator 107 produces electrical power when the water wheel and/or turbine 106 is moved by the water entering the opening 102 and falling into the interior of the housing 108. The water wheel and/or turbine 106 may comprise a rotating machine that converts hydrodynamic power into mechanical power that drives the generator 107 (and/or another set of water pumps), which produces electrical power. The amount of power generated by the generator 107 is proportional to the amount of water falling into the housing 108 and is further proportional to the distance from the opening 102 to the turbine 106.

The hydrodynamic energy system may further include a reservoir 120 located below the water wheel 106, wherein the reservoir 120 holds water that has travelled via the water wheel 106. The reservoir 120 may comprise a volume that extends horizontally past a horizontal width of the housing 108. For example, FIG. 1 shows that reservoir 120 is a horizontally aligned tubular structure that extends in the horizontal direction far past the horizontal width of the vertically aligned housing 108.

The system may further include at least one pump 110 for jettisoning water from the reservoir 120. The at least one pump 110 may be located in a horizontal direction past a horizontal width of the housing 108. See FIG. 1, which shows that the pump 110 is located at the far left, in the horizontal direction, far past the horizontal width of the vertically aligned housing 108. The purpose of pump 110 is to maintain a predefined amount of water 114 in the reservoir 120, so as to neutralize, or substantially reduce or eliminate buoyancy forces acting on the system 100. The pump 110 operates so as to not allow the amount of water 114 to rise over a predefined horizontal line, for the purpose of counteracting buoyancy forces acting on the system 100. Another purpose or function of pump 110 is to ensure that the amount of water being pumped out of the housing 108 is equal to or greater than the amount of water entering the housing 108 via the opening 102, so as to avoid a situation where the entire volume of housing 108 is filled with water. Another purpose or function of pump 110 may be to ensure that the amount of energy exerted on the water being pumped out of the housing 108 is enough to maintain water flow equal to or greater than the amount of water entering the housing 108 via the opening 102, so as to avoid a situation where the entire volume of housing 108 is filled with water, thereby causing a decrease in efficiency.

FIG. 1 also shows another pump 112 for jettisoning water from the reservoir 120. The pump 112 may also be located in a horizontal direction past a horizontal width of the housing 108. See FIG. 1, which shows that the pump 112 is located at the far right, in the horizontal direction, far past the horizontal width of the vertically aligned housing 108. The purpose of pump 112 is similar or identical to pump 110 and this pump 112 may work in conjunction with pump 110.

The system 100 may further include a first sensor 116 for detecting water flow as water falls into the housing 108 via the opening 102. The first sensor 116 may be an accelerometer, a water flow sensor, a temperature sensor, a conductance measurement device, a barometer, a pressure sensor, etc. The system 100 may also include a second sensor 117 for detecting an amount of water 114 in the reservoir 120. The second sensor 117 may be an accelerometer, a water flow sensor, a temperature sensor, a conductance measurement device, a barometer, a pressure sensor, etc. In FIG. 1, the first and second sensors 116, 117 may be one integrated unit or may comprise a plurality of sensors distributed throughout the system 100 in different locations.

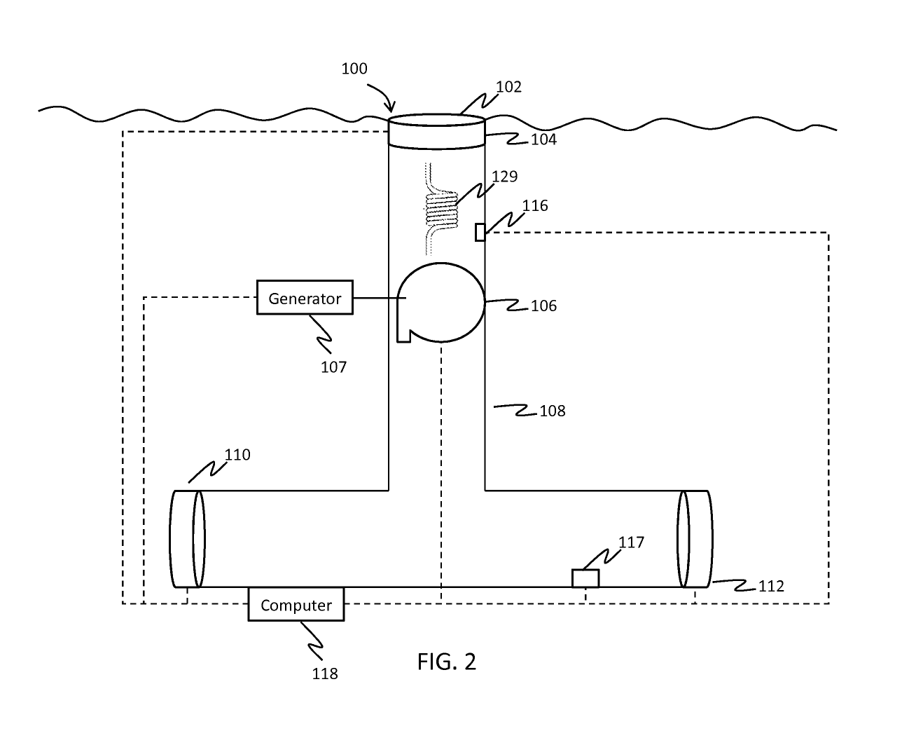

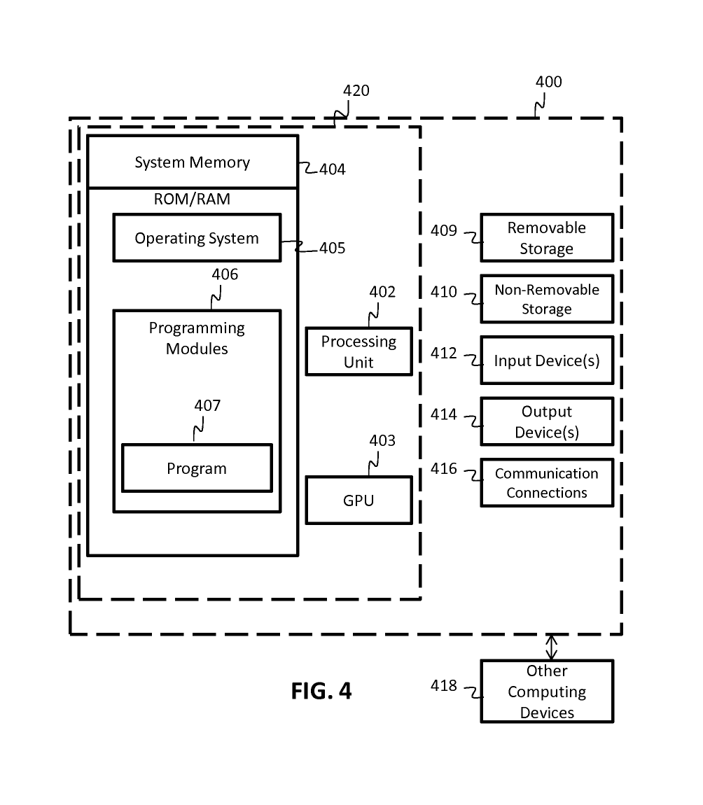

The hydrodynamic energy generation 100 may further include a computer or control processor 118. As shown in FIG. 2, the computer 118 may be communicatively coupled with valve 104, generator 107, water wheel or turbine 106, pump 110, pump 112, and sensors 116, 117. In one embodiment, processor 118 may be a central processing unit, microprocessor, integrated circuit, programmable device or computing device, as defined below with reference to FIG. 4. The control processor 118 is configured for reading data from the first and second sensors 116, 117, generator 107, and turbine 106 and sending control signals to the valve 104 and the pumps 110, 112, wherein the control signals are configured to activate the valve 104 to regulate an amount of water that enters the opening 102 at the top of housing 108, and to activate the pumps 110, 112 to regulate an amount of water maintained in the reservoir 120, such that the system 100 is maintained at neutral buoyancy. The control signals sent to the valve 104 and the pumps 110, 112, may further be configured such that the amount of water 114 within reservoir 120 is not to be allowed to rise over a predefined line, for the purpose of substantially reducing or eliminating buoyancy forces acting the system 100 due to the body of water in which the system 100 is submerged. The control signals sent to the valve 104 and the pumps 110, 112, may also be configured such that the amount of water being pumped out of the housing 108 is equal to or greater than the amount of water entering the housing 108 via the opening 102, so as to avoid a situation where the entire volume of housing 108 is filled with water.

The hydrodynamic energy generation 100 may further be mechanically stationed and fixed steady in place, such as attaching the system to one or more concrete pads, metal constructions or any other fixed support 121, as shown in FIG. 1. In one embodiment, the housing 108 includes a filter coupled to the valve 102 at the top of the housing 108, wherein the filter eliminates unwanted debris from the water flowing through the valve 104. It is desirable to eliminate the intake of debris and other unwanted material so as to reduce or eliminate clogs and other malfunctions. In another embodiment, the housing 108 includes a vertically-aligned spiral tubular structure 129 located below the valve 104 at the top of the housing, wherein the spiral tubular structure 129 provides a path for water falling into the housing 108. The vertically-aligned spiral tubular structure 129 may serve to accelerate and organized the water flow, such that the subject water may rotate and acquire more speed and/or torque as it travels through the spiral.

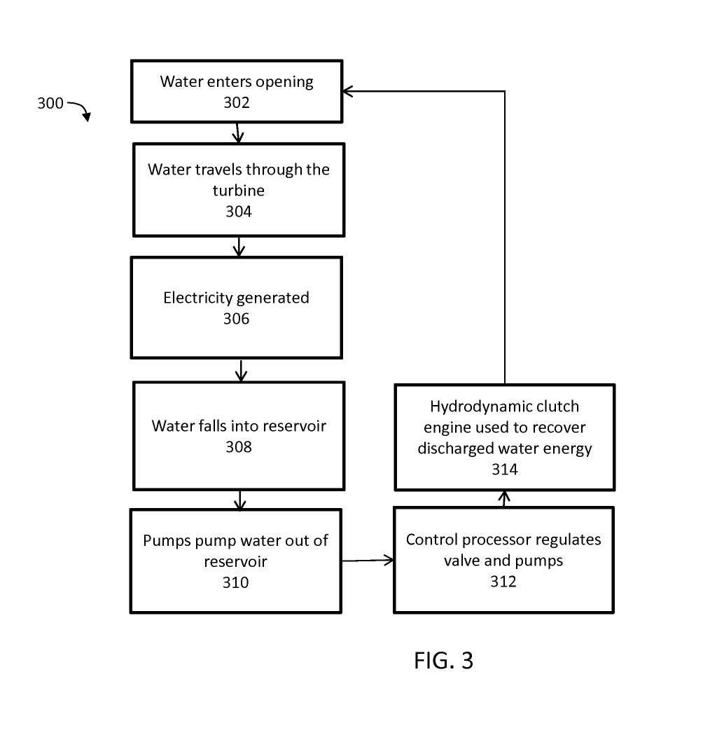

FIG. 3 is a flow chart depicting the method 300 of the progressive hydrodynamic energy generation system 100, in accordance with one embodiment. In step 302, the water from the body of water enters the opening 102 of the system 100 and in step 304, the water travels through the water wheel and/or turbine 106. In step 306, the water wheel and/or turbine 106 turns, thereby driving the generator 107 and generating power or electricity. In step 208, the water that traveled through the water wheel and/or turbine 106 falls into the reservoir 120 through a virtual space where there may be no buoyancy forces opposing the gravity force that is driving the water flow. In step 310, the pumps 110, 112 jettison water from the reservoir 120.

In step 312, the control processor 118 reads data from the first and second sensors 116, 117, generator 107, and turbine 106 and sends control signals to the valve 104 and the pumps 110, 112, wherein the control signals are configured to activate the valve 104 to regulate an amount of water that enters the opening 102 at the top of housing 108, and to activate the pumps 110, 112 to regulate an amount of water maintained in the reservoir 120, such that the system 100 is maintained at neutral buoyancy. The control signals sent to the valve 104 and the pumps 110, 112, may further be configured such that the amount of water 114 within reservoir 120 is not to be allowed to rise over a predefined line, for the purpose of substantially reducing or eliminating buoyancy forces acting on the system 100 due to the body of water in which the system 100 is submerged. The control signals sent to the valve 104 and the pumps 110, 112, may also be configured such that the amount of water being pumped out of the housing 108 is equal to or greater than the amount of water entering the housing 108 via the opening 102, so as to avoid a situation where the entire volume of housing 108 is filled with water.

In one embodiment, the control processor 118 receives data from the first and second sensors 116, 117, generator 107, and turbine 106 and uses a formula to calculate how much the valve 104 must be opened or closed, and how much the pumps 110, 112 must be adjusted in order to: 1) substantially reduce or eliminate buoyancy forces acting on the system 100, and/or 2) insure that the amount of water being pumped out of the housing 108 is equal to or greater than the amount of water entering the housing 108 via the opening 102. Based on said calculation, the processor 118 creates data commands to send to valve 104 and the pumps 110, 112, which are transmitted in step 312. In step 314, the discharged or jettisoned water may be managed to recover its hydrodynamic energy at a certain efficiency using a hydrodynamic clutch engine. Consequently, control flows back to step 302 where the entire process is executed again.

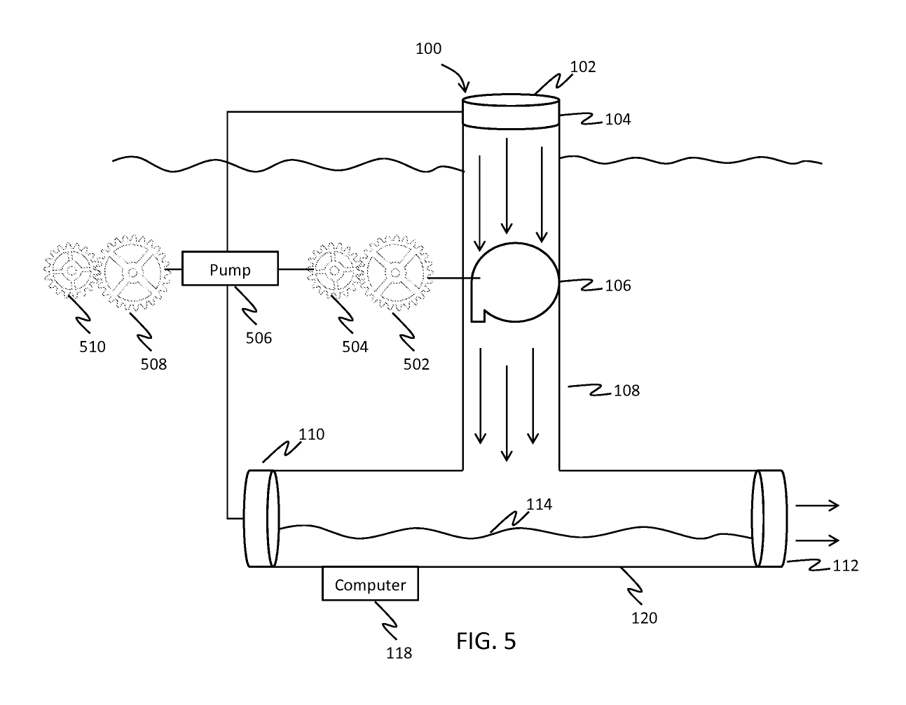

Following are a description of various alternative embodiments for the present invention. FIG. 1 shows a water wheel or turbine 106 that is mechanically coupled to a generator 107 that produces electrical power when the water wheel is moved by water that falls into the housing. In one alternative, (See FIG. 5) the water wheel or turbine 106 is mechanically coupled in a gear interface to a multi set system. The water wheel or turbine 106 may be mechanically coupled (such as via an axle) to a first set of gears including a large gear (or disk) 502 and a small gear (or disk) 504, wherein the small gear (or disk) 504 moves at a higher rotational speed to drive a second water pump 506. The water pump 506 may, for example, be a part of a closed system wherein water is pumped out of the reservoir 120 and directly to the opening 102 of the housing 108. The water pump 506 may operate at a higher capacity than the pumps 110, 112. The second water pump 506 may further power a second set of gears including a large gear 508 and a small gear 510, wherein the small gear 510 moves at a higher rotational speed. Subsequently, the small gear 510 drives another generator, another set of gears, another pump, etc. In one embodiment, various sets of gears may be chained in sequence to propagate power to other systems, pumps or sets of gears.

As shown in FIG. 5, the valve 104 may also be configured to be a continuation of a closed path or a closed circuit of water flow where the water entering the system 100 is being pumped directly from reservoir 120 via pump 506. In said configuration, the valve 104 may be located above the water line of the body of water in which the system 100 is submerged. One or more pumps may also be configured in position anywhere between the reservoir 12 and the valve 104.

In another alternative embodiment, the housing 108 may comprise multiple compartments or tubular structures that direct incoming water to different components. The multiple compartments or tubular structures are used to provide dedicates flowing water to specific components, such as specific pumps, turbines, water wheels or sensors.

In yet another alternative embodiment, the system 100 may include multiple such systems, including housings with various volumes of water and varying water speeds. Two systems may be configured to interface mechanically, using a gear, so that a turbine of one system may drive a pump of another system. Multiple systems may be configured separately so that the energy produced from one system is converted to electricity and used to drive a pump of another system.

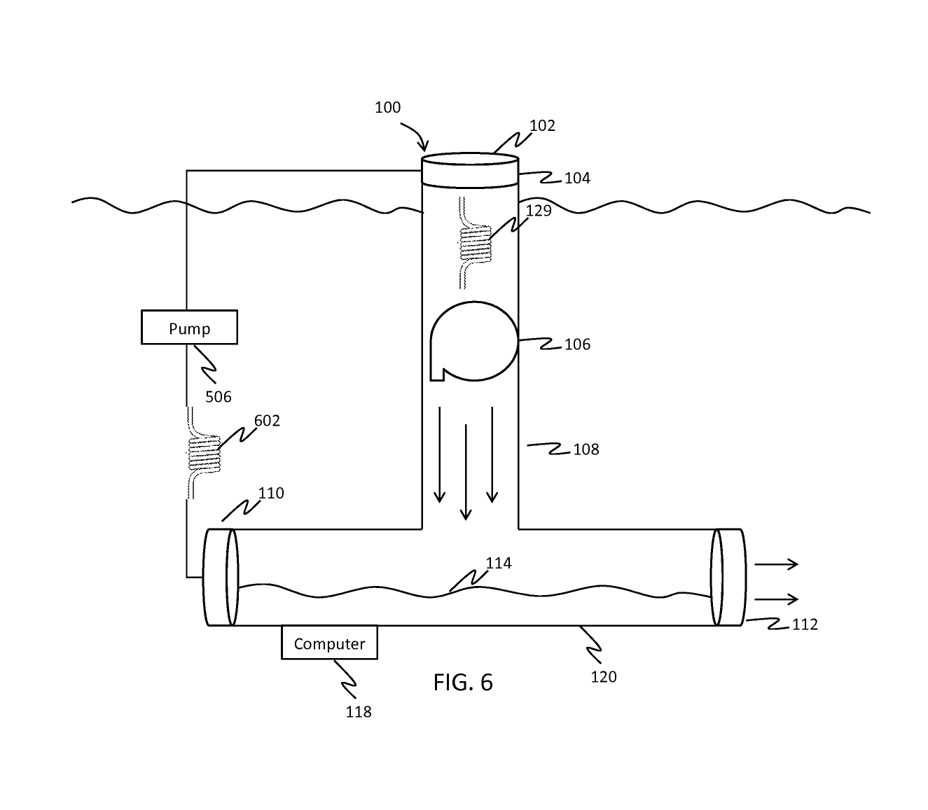

In yet another alternative, (see FIG. 6) the housing 108 includes the vertically-aligned spiral tubular structure 129 located below the valve 104 at the top of the housing, as well as a vertically-aligned spiral tubular structure 602 located exterior to the housing 108. The water pump 506 may, for example, be a part of a closed system wherein water is pumped out of the reservoir 120 and directly to the opening 102 of the housing 108. The spiral tubular structure 602 provides a path for water being pumped out of the housing 108 and the spiral tubular structure 129 provides a path for water falling into the housing 108. The vertically-aligned spiral tubular structures 602, 129 may serve to accelerate and organized the water flow, such that the subject water may rotate and acquire more speed and/or torque as it travels through the spiral.

FIG. 4 is a block diagram of a system including an example computing device 400 and other computing devices. Consistent with the embodiments described herein, the aforementioned actions performed by computer 118 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for the method shown in FIG. 3 above.

With reference to FIG. 4, a system consistent with an embodiment of the invention may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination or memory. System memory 404 may include operating system 405, one or more programming modules 406 (such as program module 407). Operating system 405, for example, may be suitable for controlling computing device 400's operation. In one embodiment, programming modules 406 may include, for example, a program module 407. Furthermore, embodiments of the invention may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. The aforementioned devices are only examples, and other devices may be added or substituted.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 may perform processes including, for example, one or more of the methods shown in FIG. 3 above. Computing device 402 may also include a graphics processing unit 403, which supplements the processing capabilities of processor 402 and which may execute programming modules 406, including all or a portion of those processes and methods shown in FIG. 3 above. The aforementioned processes are examples, and processing units 402, 403 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A hydrodynamic energy generation system, comprising:
a vertically aligned housing comprising a hollow interior and an opening at a top, wherein the housing is at least partially submerged in a body of water;
a valve coupled to the top of the housing for regulating an amount of water that enters the opening at the top and falls into the housing, wherein the valve is located at or under a water line;
a water wheel located below the valve and within the housing, wherein the water wheel is mechanically coupled to a generator that produces electrical power when the water wheel is moved by water that falls into the housing;
a reservoir located below the water wheel and within the housing, wherein the reservoir holds the water that has travelled via the water wheel; and
at least one pump for jettisoning water from the reservoir and directly into the body of water, wherein a predefined amount of water is maintained in the reservoir so as to substantially eliminate buoyancy forces on the system.

2. The hydrodynamic energy generation system of claim 1, further comprising a first sensor for detecting water flow through the housing.

3. The hydrodynamic energy generation system of claim 2, further comprising a second sensor for detecting the amount of water in the reservoir.

4. The hydrodynamic energy generation system of claim 3, further comprising a control processor communicatively coupled with the valve, the at least one pump and the first and second sensors.

5. The hydrodynamic energy generation system of claim 4, wherein the control processor is configured for reading data from the first and second sensors, and sending control signals to the valve and the at least one pump, wherein the control signals are configured to adjust the valve to regulate an amount of water that enters the opening at the top, and to activate the at least one pump to regulate an amount of water maintained in the reservoir so as to substantially eliminate buoyancy forces on the system.

6. The hydrodynamic energy generation system of claim 5, further comprising a unidirectional valve located below the valve at the top of the housing, wherein the unidirectional valve only allows water to flow in one direction.

7. The hydrodynamic energy generation system of claim 6, further comprising a filter coupled to the valve at the top of the housing for regulating an amount of water that enters the opening at the top and falls into the housing, wherein the filter eliminates unwanted debris from the water flowing through the valve at the top of the housing.

8. The hydrodynamic energy generation system of claim 7, further comprising a vertically-aligned spiral tubular structure located below the valve at the top of the housing, wherein the spiral tubular structure provides a path for water falling into the housing.

9. The hydrodynamic energy generation system of claim 8, wherein the reservoir comprises a volume that extends horizontally past a horizontal width of the housing.

10. The hydrodynamic energy generation system of claim 9, wherein the at least one pump is located in a horizontal direction past a horizontal width of the housing.

11. A hydrodynamic energy generation system, comprising:
a vertically aligned housing comprising a hollow interior and an opening at a top, wherein the housing is at least partially submerged in a body of water;
a valve coupled to the top of the housing for regulating an amount of water that enters the opening at the top and falls into the housing, wherein the valve is located at or under a water line;
a water wheel located below the valve and within the housing, wherein the water wheel is mechanically coupled to a generator that produces electrical power when the water wheel is moved by water that falls into the housing;
a reservoir located below the water wheel and within the housing, wherein the reservoir holds the water that has travelled via the water wheel;
at least one pump for jettisoning water from the reservoir and directly into the body of water, wherein a predefined amount of water is maintained in the reservoir so as to substantially eliminate buoyancy forces on the system; and
a control processor coupled with the valve and the at least one pump for controlling said valve and the at least one pump.

12. The hydrodynamic energy generation system of claim 11, further comprising a first sensor for detecting water flow through the housing.

13. The hydrodynamic energy generation system of claim 12, further comprising a second sensor for detecting the amount of water in the reservoir.

14. The hydrodynamic energy generation system of claim 13, wherein the control processor is communicatively coupled with the first and second sensors.

15. The hydrodynamic energy generation system of claim 14, wherein the control processor is configured for reading data from the first and second sensors, and sending control signals to the valve and the at least one pump, wherein the control signals are configured to adjust the valve to regulate an amount of water that enters the opening at the top, and to activate the at least one pump to regulate an amount of water maintained in the reservoir so as to substantially eliminate buoyancy forces on the system.

16. The hydrodynamic energy generation system of claim 15, further comprising a unidirectional valve located below the valve at the top of the housing, wherein the unidirectional valve only allows water to flow in one direction.

17. The hydrodynamic energy generation system of claim 16, further comprising a filter coupled to the valve at the top of the housing for regulating an amount of water that enters the opening at the top and falls into the housing, wherein the filter eliminates unwanted debris from the water flowing through the valve at the top of the housing.

18. The hydrodynamic energy generation system of claim 17, further comprising a vertically-aligned spiral tubular structure located below the valve at the top of the housing, wherein the spiral tubular structure provides a path for water falling into the housing.

19. The hydrodynamic energy generation system of claim 18, wherein the reservoir comprises a volume that extends horizontally past a horizontal width of the housing.

20. The hydrodynamic energy generation system of claim 11, further including two sets of gears coupled to each other, comprising:
a set of gears mechanically coupled with the water wheel, wherein the first set of gears comprises a larger disk that is mechanically driven by the water wheel and a smaller disk that is driven by the larger disk; and
a pump that is powered by the smaller disk of the set of gears, wherein the pump is integrated within a second set of gears such that the pump drives a larger disk of the second set of gears.
